(19) United States
(12) Patent Application Publication
(10) Pub. No.: US 2007/0159282 A1
(43) Pub. Date: Jul. 12, 2007

(54) Embedded inductor structure and manufacturing method thereof

(75) Inventors: Neng-Kuei Huang, Taoyuan Hsien (TW); Ching-Man Kao, Taoyuan Hsien (TW); Han-Cheng Hsu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC., Taoyuan Hsien (TW)

(21) Appl. No.: 11/651,077

(22) Filed: Jan. 9, 2007

(30) Foreign Application Priority Data
Jan. 11, 2006 (TW) 095101003

(51) Int. Cl. H01F 27/02

(52) U.S. Cl. 336/83

(57) ABSTRACT

An embedded inductor structure includes at least one coil and a magnetic body. The coil is formed by winding a conductive wire from a central portion to both ends. The coil is embedded in the magnetic body.

### CROSS REFERENCE TO RELATED APPLICATIONS

This Non-provisional application claims priority under 35 U.S.C. § 119(a) on Patent Application No(s). 095101003 filed in Taiwan, Republic of China on Jan. 11, 2006, the entire contents of which are hereby incorporated by reference.

### BACKGROUND OF THE INVENTION

1. Field of Invention

The invention relates to an embedded inductor structure and a manufacturing method thereof, and, in particular, to an embedded inductor structure formed by helically winding a coil from the central portion to both ends, and a manufacturing method thereof.

2. Related Art

With the miniaturization of electronic products, the fundamental components, such as inductor structures, also have to be miniaturized to meet the trend of element miniaturization.

Referring to FIG. 1, a conventional embedded inductor structure 1 has a coil 11, a magnetic body 12 and two terminals 13. Two ends of the coil 11 are respectively connected to the terminals 13, and the magnetic body 12 covers the coil 11. In addition, the terminals 13 are exposed from the magnetic body 12 to serve as pins of the embedded inductor structure 1.

The coil 11 has a hollow cylindrical structure formed by winding a conductive wire from one end to the other end. However, the coil 11 obtained by the conventional method of winding must have inside end to limit the size of the coil 11. The size of the coil 11 is not effectively reduced because the central portion of the coil 11 must have a central hollow space for pulling out the wire. So, the embedded inductor structure 1 is thicker and thus cannot meet the requirements of element miniaturization. Furthermore, because the coil 11 cannot completely fill the space in which the coil 11 is wound, the number of turns of the wound coil is limited under the same specification.

Thus, it is an important subject of the invention to provide an embedded inductor structure and a manufacturing method thereof so as to increase the number of turns of the wound coil and thus increase the inductance and the current load endurance under the same dimensional specification.

### SUMMARY OF THE INVENTION

In view of the foregoing, the invention is to provide an embedded inductor structure and a manufacturing method thereof so as to increase the inductance and improve the current load property under the same dimensional specification.

The invention is also to provide an embedded inductor structure having reduced size, and a manufacturing method thereof.

To achieve the above, the invention discloses an embedded inductor structure including at least one coil and a magnetic body. The coil is formed by helically winding a conductive wire from a central position to both ends and thus has a helical shape. The coil is embedded in the magnetic body.

To achieve the above, the invention also discloses a method of manufacturing an embedded inductor structure. The method includes the steps of: helically winding a conductive wire from a central position to both ends to form a helical coil, and then embedding the coil in a magnetic material.

As mentioned above, according to the embedded inductor structure and the manufacturing method thereof according to the invention, a conductive wire is wound from the central portion to both ends in a helical manner to form a helically arranged coil. Compared with the prior art, the number of turns of the invention may be increased under the same dimensional constraints. Therefore, the structure has a higher inductance to handle a higher current load.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional embedded inductor structure;

FIG. 2 is a pictorial view showing an embedded inductor structure according to a preferred embodiment of the invention;

FIG. 3 is a side view showing the embedded inductor structure according to the preferred embodiment of the invention;

FIGS. 4A and 4B show different aspects of the ends of the embedded inductor structure according to the preferred embodiment of the invention;

FIG. 5 is a flow chart showing a method of manufacturing the embedded inductor structure according to the preferred embodiment of the invention;

FIGS. 6A to 6C are schematic illustrations showing the method of manufacturing the embedded inductor structure according to the preferred embodiment of the invention;

FIG. 7 is a schematic illustration showing a method of winding a conductive wire according to another preferred embodiment of the invention; and

FIGS. 8 to 10 are flow charts showing different aspects of covering the coil with the magnetic material in the method of manufacturing the embedded inductor structure according to the preferred embodiment of the invention.

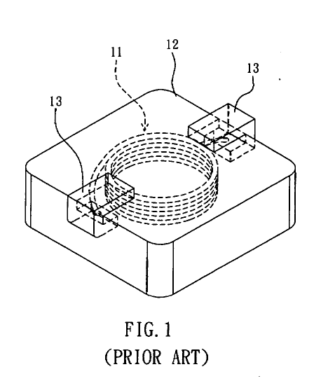

### DETAILED DESCRIPTION OF THE INVENTION

The present invention will be apparent from the following detailed description, which proceeds with reference to the accompanying drawings, wherein the same references relate to the same elements.

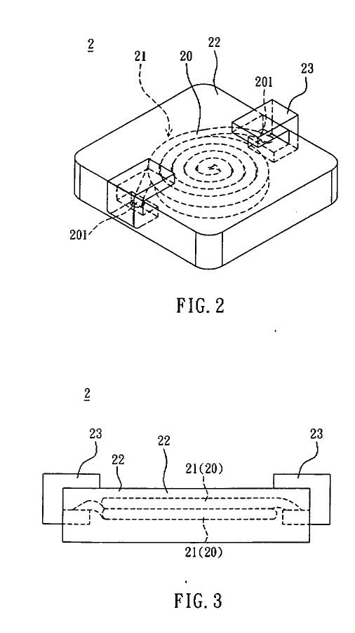

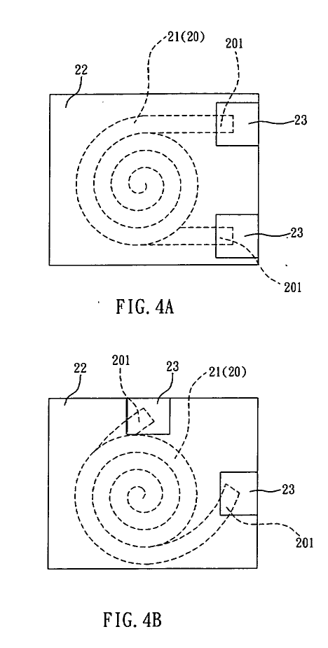

FIGS. 2 and 3 are a pictorial view and a side view showing an embedded inductor structure 2 according to a preferred embodiment of the invention. The embedded inductor structure 2 includes at least one coil 21, a magnetic body 22 and two terminals 23.

The coil 21 is formed by helically winding a conductive wire 20 from a central position to both ends 201 such that the coil 21 is tightly and helically coiled. Thus, the number of turns of the wound coil is increased to increase the inductance without increasing the bulk of the coil 21. Then, the ends 201 are respectively connected to the terminals 23 to serve as the structures to be electrically connected to an external circuit. The cross-sectional shape of the conductive wire 20 or each of the terminals 23 may be circular, elliptic, polygonal or flat. In addition, the ends 201 may directly serve as the connection portions without adding the terminals 23.

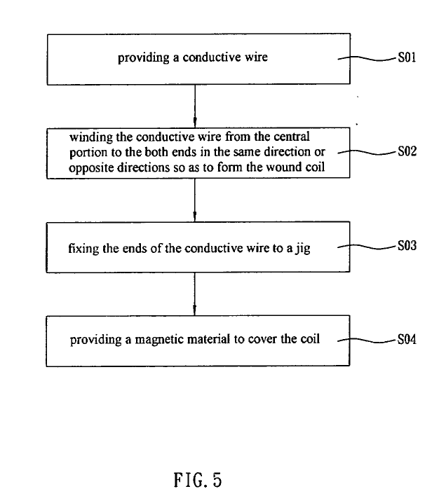

As shown in FIGS. 3, 4A and 4B, the conductive wire 20 may be wound outwards such that the ends 201 extend outwards from a periphery of the coil 21. In addition, the ends 201 may extend in the same direction or different directions. For example, the angle between the ends 201 may be 45, 90 or 180 degrees or any arbitrary value. Of course, the coil 21 is wound in a direction such that the conductive wire 20 is helically wound from the central portion to both ends 201 clockwise or counterclockwise. In addition, the winding directions of the ends 201 of the coil 21 may be the same or different from each other.

The magnetic body 22 covers the coil 21 and the terminals 23 such that the coil 21 is embedded and the terminals 23 are partially exposed from the magnetic body 22 to constitute the embedded inductor structure 2. The exposed terminals 23 serve the pins for the embedded inductor structure 2. The magnetic body 22 may be made of at least one magnetic metal powder (e.g., an iron powder or an iron-based alloy) mixed in a thermosetting resin.

In addition, the inductor structure 2 also may not need the additional terminals 23 to serve as the pins, and only the ends 201 have to be exposed from the magnetic body 22 to directly serve as the pins. Of course, the ends 201 may extend in the same direction or different directions.

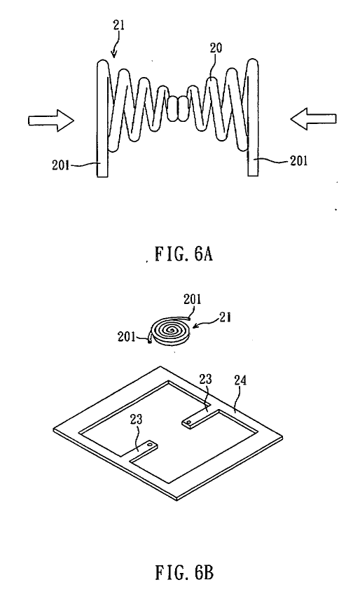

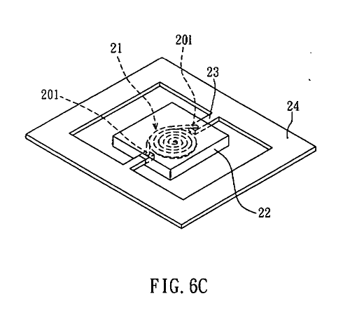

FIG. 5 is a flow chart showing a method of manufacturing the embedded inductor structure according to the preferred embodiment of the invention. FIGS. 6A to 6C are schematic illustrations showing the method of manufacturing the embedded inductor structure according to the preferred embodiment of the invention. As shown in FIGS. 5 and 6A to 6C, the manufacturing method of this embodiment may be used to manufacture the embedded inductor structure 2.

As shown in FIGS. 5 and 6A, step S01 provides the conductive wire 20 having a cross-sectional shape, which may be circular, elliptic, polygonal or flat.

Next, step S02 winds the conductive wire 20 from the central portion to the both ends 201 in the same direction or opposite directions so as to form the wound coil 21. Each end 201 of the conductive wire 20 is wound according to the above-mentioned method, and detailed descriptions thereof will be omitted. Then, the coil 21 is pressed according to the directions indicated by the arrows of FIG. 6A such that the coil 21 is arranged helically and closely. The ends 201 of the coil 21 are placed on a jig 24, as shown in FIG. 6B.

As shown in FIGS. 5 and 6C, in step S03, the ends 201 of the conductive wire 20 are fixed to the jig 24, and the portions of the jig 24 respectively fixed to the ends 201 serve as the terminals 23.

In step S04, a magnetic material is provided to cover the coil 21 and the terminals 23 such that the coil 21 is embedded and the terminals 23 are partially exposed from the magnetic body 22. Thereafter, the jig 24 is removed except for the connection portions between the jig 24 and the ends 201, and the connection portions are left to serve as the terminals 23 such that the embedded inductor structure 2 may be obtained, as shown in FIG. 2. It is to be noted that if the terminals 23 are no longer needed to serve as the pins, this step may be omitted such that the ends 201 are directly exposed from the magnetic body 22 to serve as the pins.

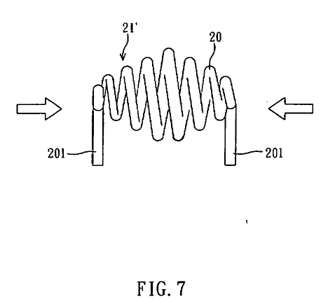

FIG. 7 is a schematic illustration showing a method of winding a conductive wire according to another preferred embodiment of the invention. As shown in FIG. 7, the difference between this embodiment and the above-mentioned embodiment is that the conductive wire 20 of this embodiment is wound inwards to obtain the coil 21′. At this time, the ends 201 of the coil 21′ extend from the central portion (e.g. the center). The other features are the same as the previous embodiment, and detailed descriptions thereof will be omitted.

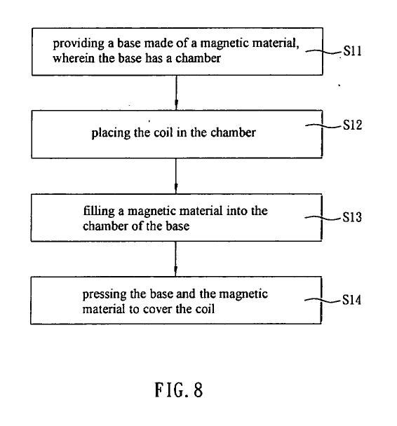

In addition, in order to make the invention easily understood, the step S04 of embedding the coil in the magnetic material according to this embodiment will be described in detail. FIG. 8 is a flow chart showing an aspect of covering the coil with the magnetic material. As shown in FIG. 8, the method includes the following steps. Step S11 provides a base made of a magnetic material, wherein the base has a chamber. Then, step S12 places the coil in the chamber. Thereafter, step S13 fills a magnetic material into the chamber of the base. Finally, step S14 presses the base and the magnetic material to cover the coil.

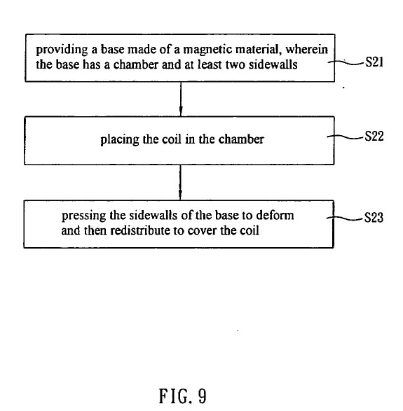

FIG. 9 is a flow chart showing another aspect of covering the coil with the magnetic material. As shown in FIG. 9, the method includes the following steps. Step S21 provides a base made of a magnetic material, wherein the base has a chamber and at least two sidewalls. Thereafter, step S22 places the coil in the chamber. Next, step S23 presses the sidewalls of the base to deform and then redistribute to cover the coil.

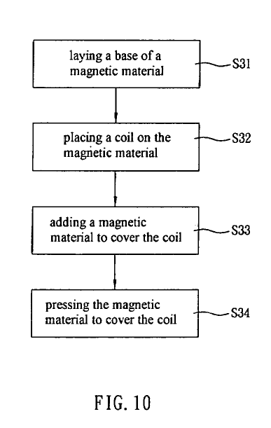

FIG. 10 is a flow chart showing still another aspect of covering the coil with the magnetic material. As shown in FIG. 10, the method includes the following steps. Step S31 lays a base of a magnetic material. Next, step S32 places the coil on the magnetic material. Then, step S33 fills a magnetic material to cover the coil. Next, step S34 presses the magnetic material to cover the coil.

In summary, according to the embedded inductor structure and the manufacturing method thereof according to the invention, a conductive wire is wound from the central portion to both ends in a helical manner to form a helically arranged coil. Compared with the prior art, the number of turns of the invention may be increased under the same dimensional constraints. Therefore, the structure has a higher inductance to handle a higher current load.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An embedded inductor structure comprising:
at least one coil formed by helically winding a conductive wire from a central portion to both ends; and
a magnetic body in which the coil is embedded.

2. The embedded inductor structure according to claim 1, wherein the conductive wire is wound from the central portion to each of the two ends in the same helical direction or opposite helical directions.

3. The embedded inductor structure according to claim 1, wherein each of the two ends of the conductive wire is wound outwards or inwards.

4. The embedded inductor structure according to claim 1, wherein the ends extend outwards from a periphery or the central portion of the coil.

5. The embedded inductor structure according to claim 1, wherein the ends after being wound extend out of the magnetic body.

6. The embedded inductor structure according to claim 5, further comprising two terminals respectively connected to the ends and exposed from the magnetic body in the same direction or different directions.

7. The embedded inductor structure according to claim 1, wherein the ends after being wound extend in the same direction or different directions.

8. The embedded inductor structure according to claim 1, wherein the ends after being wound form an angle of 45, 90 or 180 degrees.

9. The embedded inductor structure according to claim 1, further comprising two terminals respectively connected to the ends and exposed from the magnetic body in the same direction or different directions.

10. The embedded inductor structure according to claim 1, wherein a cross-sectional shape of the conductive wire is circular, elliptic, polygonal or flat.

11. The embedded inductor structure according to claim 1, wherein the magnetic body is made of at least one magnetic metal powder mixed in a thermosetting resin.

12. The embedded inductor structure according to claim 11, wherein the magnetic metal powder is an iron powder or an iron-based alloy.

13. A method of manufacturing an embedded inductor structure, the method comprising the steps of:
providing a conductive wire;
winding the conductive wire from a central portion to both ends to form a coil; and
embedding the coil in a magnetic material.

14. The method according to claim 13, wherein the ends extend outwards from a periphery or the central portion of the coil.

15. The method according to claim 13, further comprising a step, after the step of winding the conductive wire to form the coil, of:
fixing the ends of the conductive wire to a jig.

16. The method according to claim 15, wherein the jig has parts, which are respectively fixed to the ends, serving as two terminals.

17. The method according to claim 13, wherein the step of embedding the coil in the magnetic material comprises the sub-steps of:
providing a base made of a magnetic material, wherein the base has a chamber;
placing the coil in the chamber;
filling a magnetic material into the chamber of the base; and
pressing the base and the magnetic material to cover the coil.

18. The method according to claim 13, wherein the step of embedding the coil in the magnetic material comprises the sub-steps of:
providing a base, which is made of a magnetic material and has a chamber and at least two sidewalls;
placing the coil in the chamber; and
pressing the sidewalls of the base to deform and redistribute the sidewalls to cover the coil.

19. The method according to claim 13, wherein the step of embedding the coil in the magnetic material comprises the sub-steps of:
laying a base of a magnetic material;
placing the coil on the magnetic material;
filling in a magnetic material to cover the coil; and
pressing the magnetic material to cover the coil.
